(19) United States
(12) Patent Application Publication
(10) Pub. No.: US 2024/0311854 A1
(43) Pub. Date: Sep. 19, 2024

(54) OUTLIER AND INLIER ANOMALY DETECTION AND CORRECTION FOR MATERIAL REQUIREMENTS PLANNING

(71) Applicant: Dell Products L.P., Round Rock, TX (US)

(72) Inventors: Rohit Gosain, Bangalore (IN); Shibi Panikkar, Bangalore (IN)

(73) Assignee: Dell Products L.P., Round Rock, TX (US)

(21) Appl. No.: 18/182,483

(22) Filed: Mar. 13, 2023

(51) Int. Cl. G06Q 30/0202

(52) U.S. Cl. CPC G06Q 30/0202

(57) ABSTRACT

An example methodology includes receiving a forecast for a product and a forecast for a component item needed to make the product. The method also includes, responsive to a determination that the forecast for the component item is an outlier anomaly, computing an outlier corrected forecast quantity for the component item and correcting the forecast for the component item to be the computed outlier corrected forecast quantity for the component item. The method can further include computing a percentage deviation between a total corrected forecast quantity and a quantity forecasted for the component item and, responsive to a determination that the forecast for the component item is an inlier anomaly, computing an inlier corrected forecast quantity for the component item and correcting the forecast for the component item to be the computed inlier corrected forecast quantity for the component item.

### BACKGROUND

Materials Requirements Planning (MRP) provides for inventory management and production control for ordering and tracking the component items needed to manufacture products (e.g., computer products). Manufacturing organizations commonly utilize an MRP system to locate and gather the component items needed produce a desired product. Once the MRP forecasting is performed, procurement teams within the organization place orders accordioning. Thus, it is very important for the material requirements forecasts for the component items be accurate. Placing orders based on inaccurate material requirements forecasts can lead to problems such as over or under stocking, which in turn can lead to increased costs and lost sales and decreased customer satisfaction.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes receiving a forecast for a product and receiving a forecast for a component item needed to make the product. The method also includes, responsive to a determination that the forecast for the component item is an outlier anomaly, by a computing device, computing an outlier corrected forecast quantity for the component item, the outlier forecast quantity being based on an anomaly corrected quantity for the component item and a forecasted independent sales of the component item and correcting the forecast for the component item to be the computed outlier corrected forecast quantity for the component item.

In one aspect, the forecast for the product is based on historical sales of the product. In one aspect, the forecast for the component item is based on procurement history of the component item.

In some embodiments, the method further includes, responsive to the determination that the forecast for the component item is an outlier anomaly, by the computing device, generating an outlier anomaly forecast alert.

In some embodiments, the anomaly corrected quantity of the component item is a quantity of the component item needed to build a forecasted quantity of the product, wherein the forecasted quantity of the product is determined from the forecast for the product.

In some embodiments, the method also includes computing, by the computing device, a percentage deviation between a total corrected forecast quantity and a quantity forecasted for the component item. The method further includes, responsive to a determination that the forecast for the component item is an inlier anomaly, wherein the determination is based on the computed percentage deviation, by the computing device, computing an inlier corrected forecast quantity for the component item, the inlier corrected forecast quantity being based on the anomaly corrected quantity for the component item and the forecasted independent sales of the component item, and correcting the forecast for the component item to be the computed inlier corrected forecast quantity for the component item.

In some embodiments, the method further includes, responsive to the determination that the forecast for the component item is an inlier anomaly, by the computing device, generating an inlier anomaly forecast alert.

According to another illustrative embodiment provided to illustrate the broader concepts described herein, a computing device includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 shows an illustrative workflow for an outlier and inlier anomaly detection and correction process, in accordance with an embodiment of the present disclosure.

FIG. 5 is a block diagram of an illustrative system for anomaly detection and correction, in accordance with an embodiment of the present disclosure.

FIG. 6 is a flow diagram of an example process for outlier anomaly detection and correction, in accordance with an embodiment of the present disclosure.

FIG. 7 is a flow diagram of an example process for inlier anomaly detection and correction, in accordance with an embodiment of the present disclosure.

### DETAILED DESCRIPTION

Certain embodiments of the concepts, techniques, and structures disclosed herein generally relate to systems and methods for outlier and inlier anomaly detection for material requirements forecasts. The various disclosed embodiments also provide correction for detected outlier and inlier anomalies for material requirements forecasts.

As used herein, the term “outlier anomaly” refers to data points, events, and/or observations that deviate from a dataset's normal behavior. In the context of forecasts for a product, an outlier anomaly is a forecast that is not considered to be part of the overall pattern of forecasts for the product. In other words, a forecast outlier can either be overly high or overly low compared to other forecasts over time. For example, suppose past forecasts for a product are generally around 5,000 units. Given the pattern of these forecasts (i.e., other observations), a forecast of 8,000 units for the product may be considered an outlier anomaly since 8,000 units is overly high compared to 5,000 units. Similarly, a forecast of 2,500 units for the product may be considered an outlier anomaly since 2,500 units is overly low compared to 5,000 units.

As used herein, the term “inlier anomaly” refers to data points, events, and/or observations that are within the distribution of a dataset's normal behavior but are in error when considering product-component item relationships. For example, suppose one component item is needed to make a product and that a forecasted quantity for the product is 4,000 units. In this example, a forecast of 6,000 units for the component item may be within the distribution of past forecasts for the component item (e.g., not considered an outlier anomaly), but may be considered an inlier anomaly since a forecast for 6,000 units for the component item greatly exceed the number of units of the component item needed to build the forecast 4,000 units of the product.

In the description that follows, although certain embodiments and/or examples are described in the context of computer products (e.g., laptop computers) and their component items, it will be appreciated in light of this disclosure that such embodiments and/or examples are not restricted as such. For example, the concepts, techniques, and structures disclosed herein are applicable to products and articles that are built or manufactured using component items in the general sense.

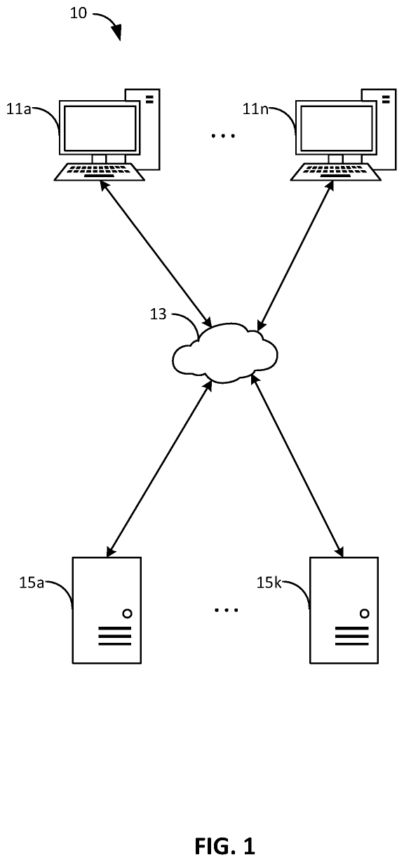

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

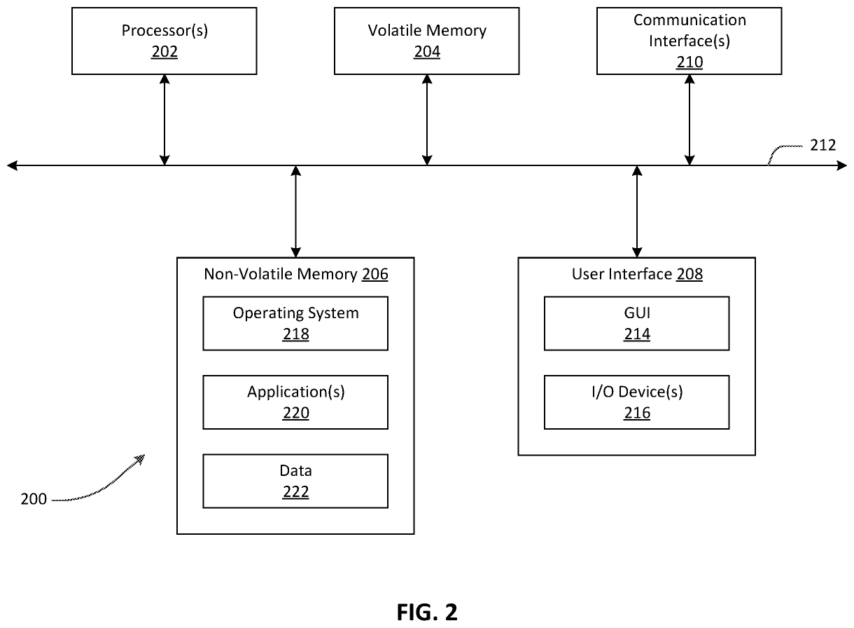

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

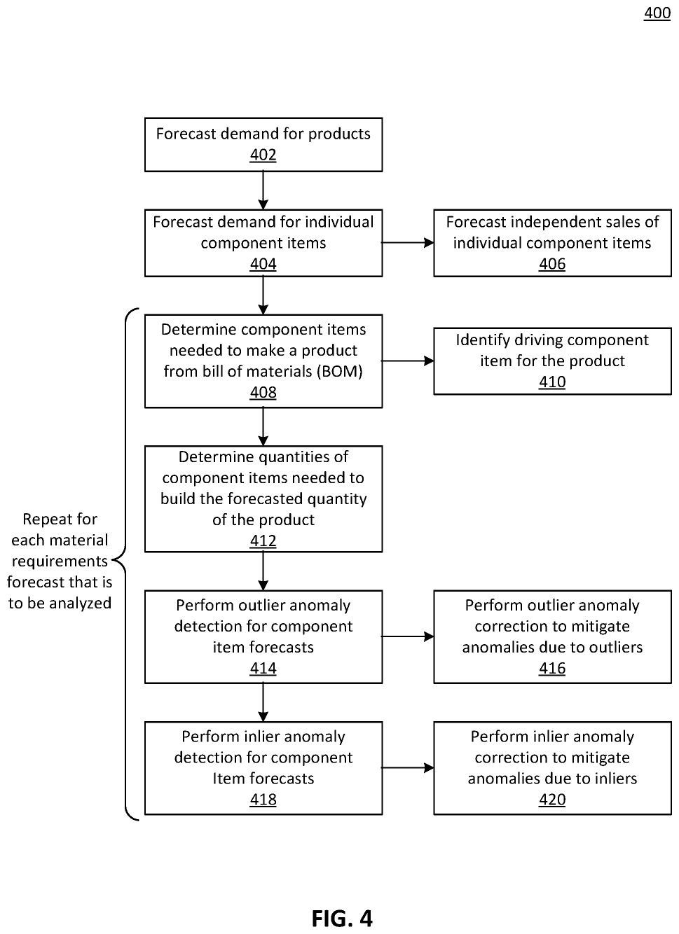

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 through 7). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

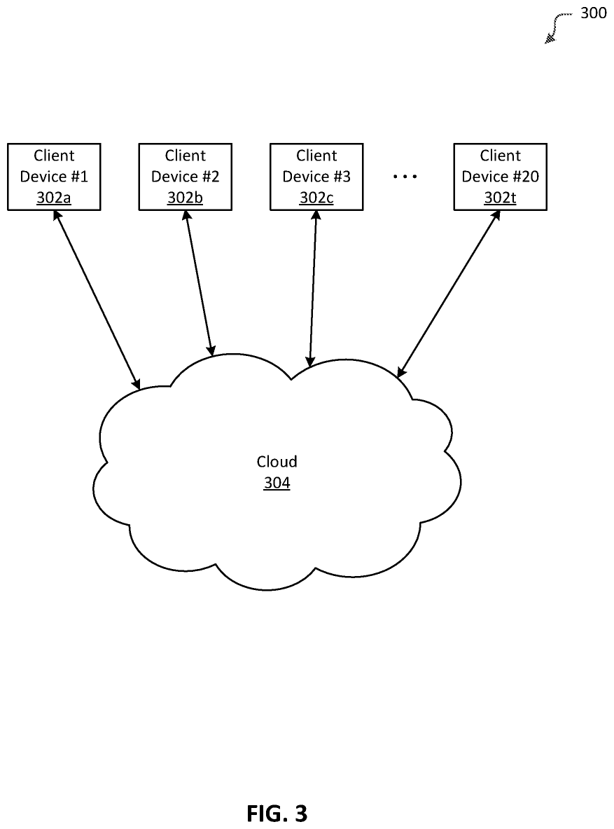

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of client devices 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a service (SaaS), Platform as a Service (PaaS), Infrastructure as a Service (IaaS), and/or Desktop as a Service (DaaS), for example. IaaS may refer to a user renting the use of infrastructure resources that are needed during a specified time period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

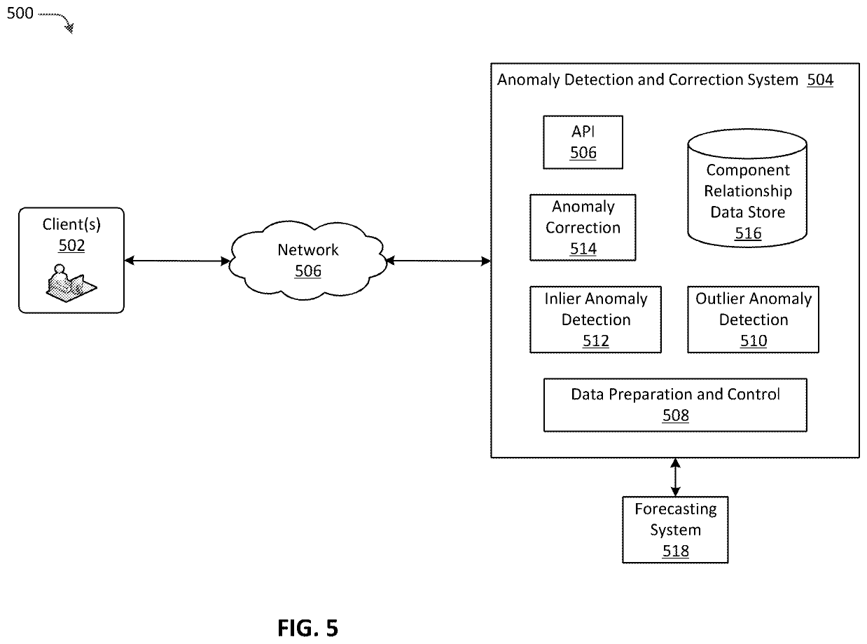

Referring now to FIG. 4, shown is an illustrative workflow 400 for an outlier and inlier anomaly detection and correction process, in accordance with an embodiment of the present disclosure. In particular, workflow 400 is an illustrative process for detecting and mitigating outlier and inlier anomalies for material requirements forecasts for component items. For example, an organization may perform outlier and inlier anomaly detection and mitigation for material requirements forecasts for component items needed to make (or “manufacture”) its products. The anomaly detection and mitigation may be performed on a periodic basis, such as, for example, biweekly, monthly, quarterly, or another suitable period. The anomaly detection and mitigation may also be performed as desired. The anomaly detection and mitigation may be for material requirements forecasts for the component items of all the organization's products or a subset of the organization's products. The operations, functions, and/or actions illustrated in workflow 400 and its corresponding description may in some embodiments be performed by a computing system such as a system 500 of FIG. 5.

With reference to workflow 400, at 402, demand for the organization's products can be forecast. The forecasts for the products (sometimes referred to herein as “product forecasts”) may be for a predetermined period such as a month, quarter, or other suitable forecast period. In some embodiments, one or more machine learning (ML) models (e.g., Random Forest, linear regression, etc.) can be utilized to forecast demand for the products based on historical product sales (i.e., based on historical sales of the product).

At 404, demand for individual component items can be forecast. The component items include the components (or “materials”) needed to make the organization's products. The forecasts for the individual component items (sometimes referred to herein as “component item forecasts”) may be for the period of the product forecasts. For example, if the product forecasts are for the next quarter, the individual component item forecasts may be for the same period (i.e., next quarter). In some embodiments, one or more ML models (e.g., Random Forest, linear regression, etc.) can be utilized to forecast the demand for the individual component items based on a component item's procurement history. A forecast that is based on procurement history is sometimes referred to herein as “procurement history-based forecast.”

At 406, independent sales of the individual component items can be forecast. The independent sales forecasts of the individual component items account for demand of the individual component items apart from the demand for the component items resulting from the product forecasts (e.g., demand for component items independent of sales of the component items as part of a product). Non-limiting examples of independent sales include component service, component replacement (e.g., part replacement), and component support. In some embodiments, one or more ML models (e.g., Random Forest, linear regression, etc.) can be utilized to forecast independent sales of the individual component items based on historical independent sales of the component items. Example forecasted independent sales of several example component items are illustrated in Table 1.

TABLE 1

| | | Forecasted |
|---|---|---|
| Part Number | Description | Independent Sales |
| AAAA | Intel Motherboard | 25 |
| BBBB | AMD Motherboard | 28 |
| CCCC | RAM - 4 GB | 24 |
| DDDD | RAM - 8 GB | 18 |
| FFFF | RAM - 16 GB | 12 |
| GGGG | Power Supply | 26 |
| HHHH | NVidea Graphics Card | 34 |
| IIII | AMD Graphics Card | 38 |

In the example of Table 1, the component items include an Intel Motherboard having part number AAAA, an AMD Motherboard having part number BBBB, a 4 GB RAM having part number CCCC, an 8 GB RAM having part number DDDD, a 16 GB RAM having part number FFFF, a Power Supply having part number GGGG, an NVidea Graphics Card having part number HHHH, and an AMD Graphics Card having part number IIII. In this example, the forecasted independent sales of part number AAAA is 25, the forecasted independent sales of part number BBBB is 28, the forecasted independent sales of part number CCCC is 24, the forecasted independent sales of part number DDDD is 18, the forecasted independent sales of part number FFFF is 12, the forecasted independent sales of part number GGGG is 26, the forecasted independent sales of part number HHHH is 34, and the forecasted independent sales of part number IIII is 38.

The operations of 408-420 described below can then be performed for each material requirements forecast for a product that is to be analyzed for anomaly detection and correction. At 408, the component items that are needed to make a particular product can be determined. For example, the component items needed to make the product can be determined from the product's bill of materials (BOM).

At 410, a driving component item for the product can also be determined from the component items needed to make the product. In other words, one of the component items needed to make the product can be designated as a driving component item for the product. The driving component item for a product refers to the component item that can be used to determine the required quantities (or “numbers”) of the other component items in the product.

At 412, quantities of the component items needed to build the forecasted quantity of the product can be determined. For example, for a particular component item needed to make the product, the quantity of the component item needed to build the forecasted quantity of the product can be calculated. Predefined product-component item relationship knowledge may be utilized in determining the quantities of the component items needed to build the forecasted quantity of the product. For example, for a product, Laptop Latitude Model 6440, 16 GB RAM, 1 TB with Graphics Card, the predefined product-component item relationship may be as shown in Table 1.

TABLE 2

| Part Number | Description | Qty |
|---|---|---|
| AAAA | Intel Motherboard | 1 |
| BBBB | AMD Motherboard | 1 |
| CCCC | RAM - 4 GB | 4 |
| DDDD | RAM - 8 GB | 2 |
| FFFF | RAM - 16 GB | 1 |
| GGGG | Power Supply | 1 |
| HHHH | NVidea Graphics Card | 2 |
| IIII | AMD Graphics Card | 2 |

In the example of Table 2, the predefined product-component item relationship for the Laptop Latitude Model 6440, 16 GB RAM, 1 TB with Graphics Card may indicate that a unit (quantity=1) of this product can be built using: one Intel Motherboard having part number AAAA or 1 AMD Motherboard having part number BBBB; four 4 GB RAM having part number CCCC, or two 8 GB RAM having part number DDDD, or one 16 GB RAM having part number FFFF; one Power Supply having part number GGGG; and two NVidea Graphics Card having part number HHHH or two AMD Graphics Card having part number IIII. In this example, the component items that can be used to build the product, Laptop Latitude Model 6440, 16 GB RAM, 1 TB with Graphics Card, include part numbers AAAA, BBBB, CCCC, DDDD, FFFF, GGGG, HHHH, and IIII. Thus, quantities of component items having part numbers AAAA, BBBB, CCCC, DDDD, FFFF, GGGG, HHHH, and IIII needed to build the forecast quantity of the product, Laptop Latitude Model 6440, 16 GB RAM, 1 TB with Graphics Card, can be determined.

At 414, outlier anomaly detection for component item forecasts can be performed. The outlier anomaly detection is for the component items that are needed to make the product (e.g., Laptop Latitude Model 6440, 16 GB RAM, 1 TB with Graphics Card). The component item forecasts may be the procurement history-based forecasts for the component items. In some embodiments, one or more ML models (e.g., One-class Support Vector Machine (SVM), K-Means, K-Distance, etc.) can be utilized for outlier anomaly detection for forecasts of the component items needed to build the product. A simplified example of outlier anomaly determination for component item forecasts is illustrated in Table 3.

TABLE 3

| Part Number | Description | Forecast (Qtr) | Is outlier? |
|---|---|---|---|
| AAAA | Intel Motherboard | 2,500 | No |
| BBBB | AMD Motherboard | 1,400 | No |
| CCCC | RAM 4 GB | 2,800 | No |
| DDDD | RAM - 8 GB | 2,300 | No |
| FFFF | RAM - 16 GB | 1,100 | No |
| GGGG | Power Supply | 6,600 | Yes |
| HHHH | NVidea Graphics Card | 4,200 | No |
| IIII | AMD Graphics Card | 1,100 | No |

In the example of Table 3, the procurement history-based forecasts are quarterly forecasts and are as follows: the forecast for part number AAAA is 2,500, the forecast for part number BBBB is 1,400, the forecast for part number CCCC is 2,800, the forecast for part number DDDD is 2,300, the forecast for part number FFFF is 1,100, the forecast for part number GGGG is 6,600, the forecast for part number HHHH is 4,200, and the forecast for part number IIII is 1,100. In this example, the forecast for the Power Supply having part number GGGG is determined to be an outlier anomaly. That is, the forecasted quantity of 6,600 for the Power Supply having part number GGGG is determined to be an outlier anomaly. For instance, past procurement history-based forecasts (e.g., past procurement history-based quarterly forecasts) for the Power Supply having part number GGGG may generally be around 3,100 units. Even assuming independent sales of 100 units for the Power Supply having part number GGGG and a reasonable deviation for forecast error, an acceptable forecast for the Power Supply having part number GGGG may be around 3,200 units. Thus, the 6,600 units forecast for the Power Supply having part number GGGG can be determined to be an outlier anomaly. In the example of Table 3, the forecasts for the other component items are determined to not be outlier anomalies.

At 416, outlier anomaly correction to mitigate anomalies due to outliers can be performed. According to one embodiment, the forecasted quantity for a component item whose forecast is determined to be an outlier anomaly can be corrected (i.e., adjusted) to an Outlier Corrected Forecast Qty as follows:

Outlier Corrected Forecast Qty=Anomaly Corrected Qty+Independent Sales Forecast Qty,

where Anomaly Corrected Qty is the quantity of the component item needed to build the forecasted quantity of the product that includes the component item (i.e., the product that needs the component item to be made) and Independent Sales Forecast Qty is the forecasted independent sales of the component item. Continuing the example above of the forecasted quantity of 6,600 for the Power Supply being determined to be an outlier anomaly, suppose the forecasted quantity for the Laptop Latitude Model 6440, 16 GB RAM, 1 TB with Graphics Card is 3,000 units. In this example, since the independent sales of the Power Supply is forecasted to be 26 units, the Outlier Corrected Qty for the Power Supply forecast can be computed to be 3,026 units (3,000+26=3,026).

For a component item whose forecast is determined to be an outlier anomaly, the Outlier Corrected Forecast Qty computed for the component item can be used as a Total Corrected Forecast Qty for the component item. Here, the Total Corrected Forecast Qty is the corrected forecast for the component item (e.g., the quantity of the component item needed to build the forecasted quantity of the product and the forecasted independent sales of the component item). For instance, in the example above, the outlier corrected forecast of 3,026 units for the Power Supply can be used as the Total Corrected Forecast Qty for the Power Supply.

At 418, inlier anomaly detection for component item forecasts can be performed. As noted above, an inlier anomaly refers to an anomaly that falls within the bounds of being determined an outlier anomaly (i.e., an anomaly that is not an outlier) and yet is an anomaly when considering product-component item relationships. The inlier anomaly detection is for the component items that are needed to make the product (e.g., Laptop Latitude Model 6440, 16 GB RAM, 1 TB with Graphics Card) and whose procurement history-based forecasts are determined to not be outlier anomalies. According to one embodiment, an inlier anomaly determination for a component item forecast may be based on a percentage deviation (% Deviation) between a Total Corrected Forecast Qty and a Forecast Qty for the component item as follows:

$$\% Deviation = \frac{( Total Corrected Forecast Qty - Forecast Qty ) \times 100}{Total Corrected Forecast Qty} ,$$

where Total Corrected Forecast Qty for the component item is the sum of the Anomaly Corrected Qty and the Independent Sales Forecast Qty for the component item, and the Forecast Qty is the quantity forecasted for the component item. Here, the Anomaly Corrected Qty for a component item is the sum of the quantity of the component item needed to build the forecasted quantity of the product that includes the component item (i.e., the product that needs the component item as a part) and the Independent Sales Forecast Qty for the component item.

In some embodiments, a predetermined % Deviation value may be used to determine an inlier anomaly. For example, if the % Deviation for a component item forecast is greater than a value N (e.g., N=20%, 25%, 30%, or any suitable value), the component item forecast can be determined to be an inlier anomaly. The value of N may be configured as part of an organizational policy or a user preference.

For example, in the above example of the Laptop Latitude Model 6440, 16 GB RAM, 1 TB with Graphics Card, the Total Corrected Forecast Qty for the Intel Motherboard can be computed to be 3,025 units (3,000+25=3,025) since one Intel Motherboard is needed in each product and the independent sales of the Intel Motherboard is forecasted to be 25 units. The Forecast Qty for the Intel Motherboard is 2,500 units, which is the procurement history-based forecast for the Intel Motherboard. As a result, the % Deviation for the Intel Motherboard is 17.36% ([(3,025−2,500)/3,025]×100=17.36%). Assuming that N=30%, the 2,500 units forecasted for the Intel Motherboard can be determined to not be an inlier anomaly since 17.36% is not greater than 30%. In other words, the forecast of 2,500 units for the Intel Motherboard can be determined to not be an inlier anomaly.

Continuing the example, the RAM can be recognized as a common component since different combinations of the RAM can be used to make the 16 GB RAM in the Laptop Latitude Model 6440. For example, four 4 GB RAM can be used to make the 16 GB, or two 8 GB RAM can be used to make the 16 GB, or one 16 GB RAM can be used to make the 16 GB. Thus, the common measuring unit of the common component, e.g., GB for the RAM, can be used as the Forecast Qty measurement unit. Using GB as the Forecast Qty measurement unit, the Anomaly Corrected Qty for the RAM can be computed to be 48,000 GB (16 GB×3,000 forecasted Laptop Latitude Model 6440=48,000 GB) and the independent sales of the RAM is forecasted to be 432 GB ([4 GB RAM×24 forecasted independent sales]+[8 GB RAM×18 forecasted independent sales]+[16 GB RAM×12 forecasted independent sales]=432 GB). As a result, the Total Corrected Forecast Qty for the RAM can be computed to be 48,432 GB (48,000 GB+432 GB=48,432 GB). The Corrected Forecast Qty for the 4 GB RAM is 11,200 GB (4 GB×procurement history-based forecast of 2,800 units=11,200 GB), the Forecast Qty for the 8 GB RAM is 18,400 GB (8 GB×procurement history-based forecast of 2,300 units=18,400 GB), and the Forecast Qty for the 16 GB RAM is 17,600 GB (16 GB×procurement history-based forecast of 1,100 units=17,600 GB). As a result, the Forecast Qty for the RAM can be computed to be 47,200 GB (11,200 GB+18,400 GB+17,600 GB=47,200 GB) and the % Deviation for the RAM is 2.54% ([(48,432−47,200)/48,432]×100=2.54%). Assuming that N=30%, the forecast of 47,200 GB for the common component RAM can be determined to not be an inlier anomaly since 2.54% is not greater than 30%.

Still continuing the example, the Total Corrected Forecast Qty for the NVidea Graphics Card can be computed to be 6,034 units (6,000+34=6,034) since two NVidea Graphics Cards are needed in each product and the independent sales of the NVidea Graphics Card is forecasted to be 34 units. The Forecast Qty for the two NVidea Graphics Card is 4,200 units, which is the procurement history-based forecast for the NVidea Graphics Card. As a result, the % Deviation for the Intel Motherboard is 30.39% ([(6,034−4,200)/6,034]×100=30.39%). Assuming that N=30%, the forecast of 4,200 units for the NVidea Graphics Card can be determined to be an inlier anomaly since 17.36% is greater than 30%.

Note that, in the Laptop Latitude Model 6440 example, the forecast for the Power Supply having part number GGGG is not analyzed for an inlier anomaly since the forecast for the Power Supply has been corrected to a Total Corrected Forecast Qty to mitigate for the outlier anomaly at 416.

At 420, inlier anomaly correction to mitigate anomaly due to inliers can be performed. According to one embodiment, the forecasted quantity for a component item whose forecast is determined to be an inlier anomaly can be corrected to an Inlier Corrected Forecast Qty as follows:

$$Inlier Corrected Forecast Qty = Anomaly Corrected Qty + Independent Sales Forecast Qty ,$$

where Anomaly Corrected Qty is the quantity of the component item needed to build the forecasted quantity of the product that includes the component item (i.e., the product that needs the component item as a part) and Independent Sales Forecast Qty is the forecasted independent sales of the component item. Continuing the example above of the forecasted quantity of 4,200 for the NVidea Graphics Card being determined to be an inlier anomaly, the Inlier Corrected Forecast Qty for the NVidea Graphics Card can be computed to be 6,034 units (6,000+34=6,034) since two NVidea Graphics Cards are needed in each product and the independent sales of the NVidea Graphics Card is forecasted to be 34 units.

Similar to outlier anomaly correction, for a component item whose forecast is determined to be an inlier anomaly, the Inlier Corrected Forecast Qty computed for the component item can be used as a Total Corrected Forecast Qty for the component item. For instance, in the example above, the inlier corrected forecast of 6,034 units for the NVidea Graphics Card can be used as the Total Corrected Forecast Qty for the NVidea Graphics Card.

Referring now to FIG. 5, shown is a block diagram of illustrative system 500 for anomaly detection and correction, in accordance with an embodiment of the present disclosure. Illustrative system 500 includes one or more clients 102 communicatively coupled to an anomaly detection and correction system 504 via a network 506. Anomaly detection and correction system 504 of FIG. 5 can be the same as or similar to anomaly detection and correction system 400 of FIG. 4.

In some embodiments, system 500 may form part a network environment, such as network environment 10 of FIG. 1. For example, clients 502 of FIG. 5 may correspond to client machines 11 of FIG. 1, anomaly detection and correction system 504 of FIG. 5 may correspond to one or more server machines 15 of FIG. 1, and network 506 of FIG. 5 may correspond to networks 13 of FIG. 1.

In some embodiments, system 500 may form part of a cloud computing environment, such as cloud computing environment 300 of FIG. 3. For example, clients 502 of FIG. 5 may correspond to client devices 302a-302t of FIG. 3, and anomaly detection and correction system 504 of FIG. 5 may correspond to a virtual or physical server providing a cloud-based service, such as SaaS.

Clients 502 may include any type of client devices configured to install and/or run applications (or “apps”). For example, a representative client 502 may run a client application, such as a web client or a dedicated application, that a user can use to access and interact with anomaly detection and correction system 504. The client application and/or anomaly detection and correction system 504 may be implemented as computer instructions executable to perform the corresponding functions disclosed herein. In the example of FIG. 5, anomaly detection and correction system 504 can include an application programming interface (API) module 506, a data preparation and control module 508, an outlier anomaly detection module 510, an inlier anomaly detection module 512, an anomaly correction module 514, and a component relationship data store 516.

The client application on client 502 can communicate with the anomaly detection and correction system 504 using an API. For example, the client application on client 502 can send requests (or “messages”) to anomaly detection and correction system 504 wherein the requests are received and processed by API module 506 or one or more other components of anomaly detection and correction system 504. Likewise, anomaly detection and correction system 504 can utilize API module 506 to send responses/messages to the client application on client 502.

Referring again to representative client 502, the client application may provide various user interface (UI) controls that enable a user, such as a procurement team member or other associate within or associated with an organization, to access and interact with anomaly detection and correction system 504. For example, the UI controls can include elements/controls, such as a list box or a text box, that a user can use to select and/or enter (e.g., specify) a product or products whose material requirements forecasts are to be analyzed for anomaly detection and correction. The UI controls can include elements/controls that a user can click/tap to request anomaly detection and correction for the specified material requirements forecasts. In response to the user's input, the client application on client 502 can send a message to anomaly detection and correction system 504 requesting analysis of the specified material requirements forecasts for detection and correction of anomalies.

The client application can also include UI controls that enable a user to view information about results of the analysis of material requirements forecasts for detection and correction of anomalies. For example, in some embodiments, responsive to sending a request for analysis of one or more material requirements forecasts for detection and correction of anomalies, the client application may receive a response from anomaly detection and correction system 504 which includes information about the results of the analysis of the specified material requirements forecasts. For example, the information can include a corrected forecast that mitigates a detected anomaly (e.g., a detected outlier anomaly and/or a detected inlier anomaly). As another example, the information can include an alert informing of a detected outlier anomaly for a forecast (e.g., informing that a forecast is an outlier anomaly). As still another example, the information can include an alert informing of a detected inlier anomaly for a forecast (e.g., informing that a forecast is an inlier anomaly). As another example, the information can include a warning informing of a possible inlier anomaly for a forecast (e.g., informing that a forecast is a possible inlier anomaly). The UI controls can include a button or other type of control/element for displaying the information about the results of the analysis provided by anomaly detection and correction system 504, for example, on a display connected to or otherwise associated with client 502.

Referring to anomaly detection and correction system 504, data preparation and control module 508 is operable to generally provide the overall control of the analysis of material requirements forecasts for detection and correction of anomalies utilizing the services and functionality of outlier anomaly detection module 510, inlier anomaly detection module 512, anomaly correction module 514, and component relationship data store 516, as necessary. For instance, in response to a request for analysis of a material requirements forecast for a product for detection and correction of anomalies being received by anomaly detection and correction system 504, data preparation and control module 508 can initiate processing of the received request and provide a response to the received request. For example, data preparation and control module 508 can analyze the forecasts for component items needed to make the product for outlier anomalies utilizing outlier anomaly detection module 510. If the analysis determines that a forecast for a component item is an outlier anomaly, data preparation and control module 508 can correct the forecast that is determined to be an outlier anomaly utilizing anomaly correction module 514. Data preparation and control module 508 can also analyze the forecasts for the component items for inlier anomalies utilizing inlier anomaly detection module 512. If the analysis determines that a forecast for a component item is an inlier anomaly, data preparation and control module 508 can correct the forecast that is determined to be an inlier anomaly utilizing anomaly correction module 514. Data preparation and control module 508 can include information about the results of the analysis in the response to the request.

In some embodiments, data preparation and control module 508 can collect or otherwise retrieve the forecasts for the organization's products, and materials related to these forecasts, from a forecasting system 518. In some embodiments, data preparation and control module 508 can also collect or otherwise retrieve the forecasts for the component items needed to make the organization's products, and materials related to these forecasts, from forecasting system 518. Forecasting system 518 may correspond to, for example, various forecasting systems utilized by or associated with the organization to perform material requirements forecasting for their products. Data preparation and control module 508 may utilize APIs provided by forecasting system 518 to collect/retrieve information and materials (e.g., material requirements forecasts) therefrom.

In some embodiments, data preparation and control module 508 can collect/retrieve the product forecasts and the component item forecasts from forecasting system 518 on a continuous or periodic basis (e.g., according to a predetermined schedule specified by the organization). In some embodiments, data preparation and control module 508 can store the forecasts collected/retrieved from forecasting system 518 within a data store (e.g., a digital repository), where it can subsequently be retrieved and used.

In some embodiments, data preparation and control module 508 can prepare the materials needed for analysis of material requirement forecasts for detection and correction of anomalies. For example, to prepare for analysis of a material requirements forecast for a product, data preparation and control module 508 can retrieve the forecast for the product. Data preparation and control module 508 can also retrieve the product's BOM for use in determining the component items that are needed to make the product. Data preparation and control module 508 can then retrieve the forecasts for the component items that are needed to make the product. In some embodiments, data preparation and control module 508 can retrieve the forecasts for the product and the component items, and related materials, from the data store used to store the forecasts.

In some embodiments, data preparation and control module 508 can retrieve the predefined product-component item relationships for the product from component relationship data store 516. For example, the organization may have defined the product-component item relationships for its products and stored (e.g., recorded) the product-component item relationship information within component relationship data store 516. Data preparation and control module 508 can use the product-component item relationship information determine the quantities of the component items needed to build the forecasted quantity of the product. In some embodiments, data preparation and control module 508 can forecast the independent sales for the component items needed to make the product. In one implementation, data preparation and control module 508 can utilize one or more ML models (e.g., Random Forest, linear regression, etc.) to forecast independent sales of the individual component items based on historical independent sales of the component items.

Outlier anomaly detection module 510 is operable to analyze the forecasts for the component items for outlier anomalies. In some embodiments, outlier anomaly detection module 510 can utilize one or more ML models (e.g., One-class SVM, K-Means, K-Distance, etc.) to detect the component item forecasts that are outlier anomalies. Outlier anomaly detection module 510 can indicate the forecasts that are outlier anomalies and the forecasts that are not outlier anomalies. In some embodiments, outlier anomaly detection module 510 can generate an alert informing of a detected outlier anomaly for a forecast.

Inlier anomaly detection module 512 is operable to analyze the forecasts for the component items for inlier anomalies. In some embodiments, for a particular forecast for a component item, inlier anomaly detection module 512 can determine whether the forecast is an inlier anomaly based on a % Deviation between a Total Corrected Forecast Qty and the forecasted quantity for the component item (i.e., the component item's forecast). The Total Corrected Forecast Qty for the component item is the quantity of the component item needed to build the forecasted quantity of the product and the forecasted independent sales of the component item. A predetermined % Deviation value for determining an inlier anomaly may be configured by the organization. By way of an example, suppose 4,000 units of a Part A are needed to build the forecasted quantity of a Product X, the forecasted independent sales of Part A is 100 units, and the forecasted quantity of Part A is 3000 units. In this example, the % Deviation for the forecast for Part A can be computed to be 26.83% ([(4,100−3,000)/4,100]×100=26.83%). Assuming that the organization has defined 25% as a threshold for determining an inlier anomaly, the 3,000 units forecasted for Part A can be determined to be an inlier anomaly since 26.83% is greater than 25%. In other words, the forecast of 3,000 units for Part A can be determined to be an inlier anomaly. In some embodiments, inlier anomaly detection module 512 can generate an alert informing of a detected inlier anomaly for a forecast.

In some embodiments, inlier anomaly detection module 512 can analyze the forecasts for the component items for possible inlier anomalies. In such embodiments, inlier anomaly detection module 512 can determine whether a forecast for a component item is a possible inlier anomaly based on a predetermined % Deviation value for determining a possible inlier anomaly. The % Deviation value for determining a possible inlier anomaly may be configured as part of an organizational policy. By way of an example, suppose the organization has defined 30% as a threshold for determining an inlier anomaly and 10% as a threshold for determining a possible inlier anomaly. In this example, a % Deviation computed for a forecast for a component item is between the 10% threshold for determining a possible inlier anomaly and the 30% threshold for determining an inlier anomaly, the forecast can be determined to be a possible inlier anomaly. In some embodiments, inlier anomaly detection module 512 can generate a warning informing of a detected possible inlier anomaly for a forecast.

Anomaly correction module 514 is operable to correct forecasts that are determined to be anomalies. In some embodiments, for a forecast for a component item determined to be an outlier anomaly, anomaly correction module 514 can correct the forecasted quantity to be an Outlier Corrected Forecast Qty, which is a sum of an Anomaly Corrected Qty and an Independent Sales Forecast Qty for the component item. In some embodiments, for a forecast for a component item determined to be an inlier anomaly, anomaly correction module 514 can correct the forecasted quantity to be an Inlier Corrected Forecast Qty, which is a sum of an Anomaly Corrected Qty and an Independent Sales Forecast Qty for the component item. In such embodiments, the Anomaly Corrected Qty is the quantity of the component item needed to build the forecasted quantity of the product (i.e., the product that needs the component item to be made) and Independent Sales Forecast Qty is the forecasted independent sales of the component item.

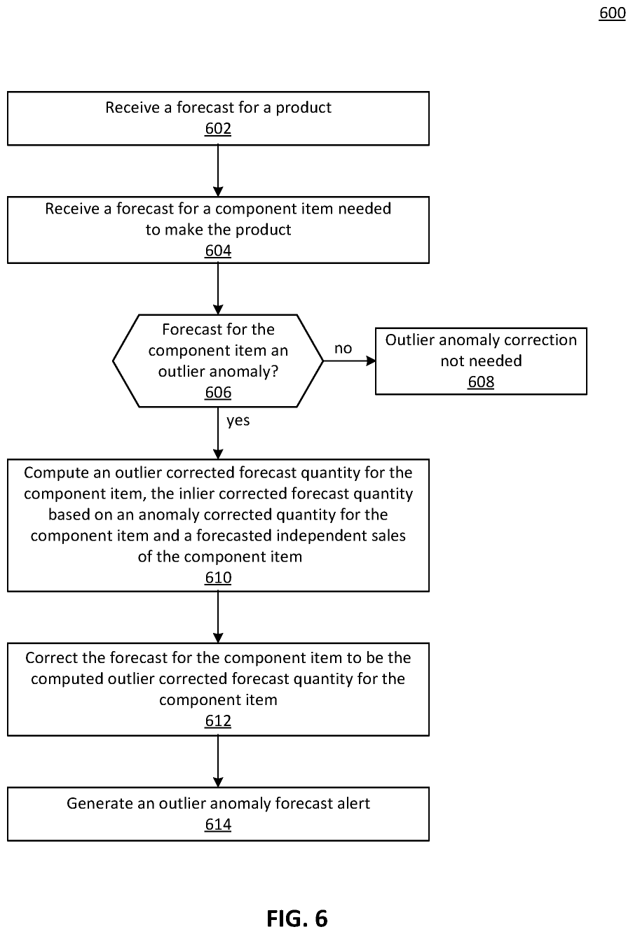

FIG. 6 is a flow diagram of an example process for outlier anomaly detection and correction, in accordance with an embodiment of the present disclosure. Illustrative process 600 may be implemented, for example, within system 500 of FIG. 5. In more detail, process 600 may be performed, for example, in whole or in part by data preparation and control module 508, outlier anomaly detection module 510, and anomaly correction module 514, or any combination of these including other components of system 500 described with respect to FIG. 5.

With reference to process 600 of FIG. 6, at 602, a forecast for a product may be received. For example, the forecast may be a material requirements forecast for the product. The forecast for the product may be based on historical sales of the product.

At 604, a forecast for a component item needed to make the product may be received. The forecast for the component item may be based on the component item's procurement history.

At 606, a check may be performed to determine whether the forecast for the component item is an outlier anomaly. The check may be based on a comparison of the forecasted quantity of the component item (i.e., the forecast for the component item) and past forecasted quantities of the component item. If it is determined that the forecast for the component item is not an outlier anomaly, then, at 608, a determination can be made that an outlier anomaly correction for the component item forecast is not needed. In some embodiments, the forecast for the component item can be indicated as not being an outlier anomaly.

Otherwise, if, at 606, it is determined that the forecast for the component item is an outlier anomaly, then, at 610, an outlier corrected forecast quantity for the component item can be computed. The outlier corrected forecast quantity can be based on an anomaly corrected quantity for the component item and a forecasted independent sales of the component item. The anomaly corrected quantity for the component item is the quantity of the component item needed to build the forecasted quantity of the product.

At 612, the forecast for the component item can be corrected. The forecasted quantity of the component item can be corrected to the outlier corrected forecast quantity for the component item computed at 610.

At 614, an outlier anomaly forecast alert may be generated. The outlier anomaly alert can inform of the forecast for the component item determined to be an outlier anomaly (e.g., inform of the forecast that is an outlier anomaly).

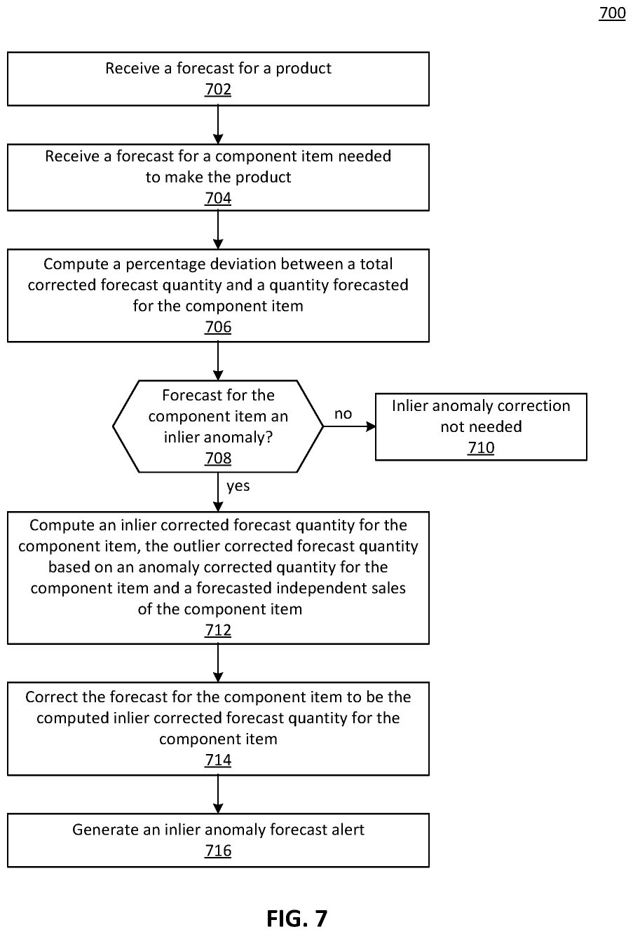

FIG. 7 is a flow diagram of an example process 700 for inlier anomaly detection and correction, in accordance with an embodiment of the present disclosure. Illustrative process 700 may be implemented, for example, within system 500 of FIG. 5. In more detail, process 700 may be performed, for example, in whole or in part by data preparation and control module 508, inlier anomaly detection module 512, and anomaly correction module 514, or any combination of these including other components of system 500 described with respect to FIG. 5.

With reference to process 700 of FIG. 7, at 702, a forecast for a product may be received. For example, the forecast may be a material requirements forecast for the product. The forecast for the product may be based on historical sales of the product.

At 704, a forecast for a component item needed to make the product may be received. The forecast for the component item may be based on the component item's procurement history.

At 706, a percentage deviation between a total corrected forecast quantity and a quantity forecasted for the component item may be computed. The total corrected forecast quantity is the quantity of the component item needed to build the forecasted quantity of the product and any forecasted independent sales of the component item. The quantity forecasted for the component item (i.e., the forecasted quantity of the component item) can be determined from the forecast for the component item.

At 708, a check may be performed to determine whether the forecast for the component item is an inlier anomaly. The check may be based on a comparison of the percentage deviation computed at 706 and a predetermined percentage deviation value for determining an inlier anomaly. If it is determined that the forecast for the component item is not an inlier anomaly, then, at 710, a determination can be made that an inlier anomaly correction for the component item forecast is not needed. In some embodiments, the forecast for the component item can be indicated as not being an inlier anomaly.

Otherwise, if, at 708, it is determined that the forecast for the component item is an inlier anomaly, then, at 712, an inlier corrected forecast quantity for the component item can be computed. The inlier corrected forecast quantity can be based on an anomaly corrected quantity for the component item and a forecasted independent sales of the component item. The anomaly corrected quantity for the component item is the quantity of the component item needed to build the forecasted quantity of the product.

At 714, the forecast for the component item can be corrected. The forecasted quantity of the component item can be corrected to the outlier corrected forecast quantity for the component item computed at 712.

At 716, an inlier anomaly forecast alert may be generated. The inlier anomaly alert can inform of the forecast for the component item determined to be an inlier anomaly (e.g., inform of the forecast that is an inlier anomaly).

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, a forecast for a product;
receiving, by the computing device, a forecast for a component item needed to make the product; and
responsive to a determination that the forecast for the component item is an outlier anomaly, by the computing device:
computing an outlier corrected forecast quantity for the component item, the outlier forecast quantity being based on an anomaly corrected quantity for the component item and a forecasted independent sales of the component item; and
correcting the forecast for the component item to be the computed outlier corrected forecast quantity for the component item.

2. The method of claim 1, further comprising, responsive to the determination that the forecast for the component item is an outlier anomaly, by the computing device, generating an outlier anomaly forecast alert.

3. The method of claim 1, wherein the forecast for the product is based on historical sales of the product.

4. The method of claim 1, wherein the forecast for the component item is based on procurement history of the component item.

5. The method of claim 1, wherein the anomaly corrected quantity of the component item is a quantity of the component item needed to build a forecasted quantity of the product, wherein the forecasted quantity of the product is determined from the forecast for the product.

6. The method of claim 1, further comprising:
computing, by the computing device, a percentage deviation between a total corrected forecast quantity and a quantity forecasted for the component item; and
responsive to a determination that the forecast for the component item is an inlier anomaly, wherein the determination is based on the computed percentage deviation, by the computing device:
computing an inlier corrected forecast quantity for the component item, the inlier corrected forecast quantity being based on the anomaly corrected quantity for the component item and the forecasted independent sales of the component item; and
correcting the forecast for the component item to be the computed inlier corrected forecast quantity for the component item.

7. The method of claim 6, further comprising, responsive to the determination that the forecast for the component item is an inlier anomaly, by the computing device, generating an inlier anomaly forecast alert.

8. A computing device comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving a forecast for a product;
receiving a forecast for a component item needed to make the product; and
responsive to a determination that the forecast for the component item is an outlier anomaly:
computing an outlier corrected forecast quantity for the component item, the outlier forecast quantity being based on an anomaly corrected quantity for the component item and a forecasted independent sales of the component item; and
correcting the forecast for the component item to be the computed outlier corrected forecast quantity for the component item.

9. The computing device of claim 8, wherein the process further comprises, responsive to the determination that the forecast for the component item is an outlier anomaly, generating an outlier anomaly forecast alert.

10. The computing device of claim 8, wherein the forecast for the product is based on historical sales of the product.

11. The computing device of claim 8, wherein the forecast for the component item is based on procurement history of the component item.

12. The computing device of claim 8, wherein the anomaly corrected quantity of the component item is a quantity of the component item needed to build a forecasted quantity of the product, wherein the forecasted quantity of the product is determined from the forecast for the product.

13. The computing device of claim 8, wherein the process further comprises:
computing a percentage deviation between a total corrected forecast quantity and a quantity forecasted for the component item; and
responsive to a determination that the forecast for the component item is an inlier anomaly, wherein the determination is based on the computed percentage deviation:
computing an inlier corrected forecast quantity for the component item, the inlier forecast quantity being based on the anomaly corrected quantity for the component item and the forecasted independent sales of the component item; and
correcting the forecast for the component item to be the computed inlier corrected forecast quantity for the component item.

14. The computing device of claim 13, wherein the process further comprises, responsive to the determination that the forecast for the component item is an inlier anomaly, generating an inlier anomaly forecast alert.

15. A non-transitory machine-readable medium encoding instructions that when executed by one or more processors cause a process to be carried out, the process including:
receiving a forecast for a product;
receiving a forecast for a component item needed to make the product; and
responsive to a determination that the forecast for the component item is an outlier anomaly:
computing an outlier corrected forecast quantity for the component item, the outlier forecast quantity being based on an anomaly corrected quantity for the component item and a forecasted independent sales of the component item; and
correcting the forecast for the component item to be the computed outlier corrected forecast quantity for the component item.

16. The machine-readable medium of claim 15, wherein the process further comprises, responsive to the determination that the forecast for the component item is an outlier anomaly, generating an outlier anomaly forecast alert.

17. The machine-readable medium of claim 15, wherein the forecast for the product is based on historical sales of the product, and wherein the forecast for the component item is based on procurement history of the component item.

18. The machine-readable medium of claim 15, wherein the anomaly corrected quantity of the component item is a quantity of the component item needed to build a forecasted quantity of the product, wherein the forecasted quantity of the product is determined from the forecast for the product.

19. The machine-readable medium of claim 15, wherein the process further comprises:
computing a percentage deviation between a total corrected forecast quantity and a quantity forecasted for the component item; and
responsive to a determination that the forecast for the component item is an inlier anomaly, wherein the determination is based on the computed percentage deviation:
computing an inlier corrected forecast quantity for the component item, the inlier forecast quantity being based on the anomaly corrected quantity for the component item and the forecasted independent sales of the component item; and
correcting the forecast for the component item to be the computed inlier corrected forecast quantity for the component item.

20. The machine-readable medium of claim 19, wherein the process further comprises, responsive to the determination that the forecast for the component item is an inlier anomaly, generating an inlier anomaly forecast alert.
